(19) United States
(12) Patent Application Publication
(10) Pub. No.: US 2007/0084544 A1
(43) Pub. Date: Apr. 19, 2007

(54) Corrugated cardboard with pre-printed face liner

(76) Inventor: Brian Crompton Jones, Waddington (GB)

Correspondence Address: MOORE & VAN ALLEN PLLC, P.O. BOX 13706, Research Triangle Park, NC, 27709, US

(21) Appl. No.: 10/556,157

(22) PCT Filed: May 6, 2004
(86) PCT No.: PCT/GB04/01948

§ 371 Date: Apr. 5, 2006

(30) Foreign Application Priority Data
May 16, 2003 (GB) 0311244.8

(51) Int. Cl. B31F 1/20; B31F 1/00; B31F 1/07; B32B 38/06

(52) U.S. Cl. 156/210; 156/209; 156/199; 156/459; 156/443; 156/462; 156/467; 156/269

(57) ABSTRACT

A laminated single faced flute comprises a fluted layer (12) and a printed facing sheet (14). The fluted layer (12) comprises an embossed layer. The laminated single faced flute only comprises a single embossed layer and a single facing sheet. Accordingly, a high resolution print is not simply provided as a separate layer and adhered to the facing sheet which would thereby results in the three layers. The laminated single faced flute (10) may be used in packaging to prevent damaged products contained therein. In addition, the laminated single faced flute may be used as a holder (20) to hold and retain warm or hot products therein, cups or hot drinks or soup etc. The image is printed on the facing sheet (14) prior to adhering the facing sheet (14) to the embossed web (12). This thereby retains the characteristic of the flute.

### FIELD OF THE INVENTION

The present invention relates to a method of producing a single faced laminate, a machine for producing a single faced laminate and a holder comprising a single faced laminate.

### BACKGROUND TO THE INVENTION

Conventional “double-faced” printed corrugated packaging comprises three layers of paper. Such corrugated material generally comprises a first flat sheet spaced from a second printed flat sheet by a corrugated layer, namely a flute, located therebetween. There are three ways in which the print can be applied. A first method includes pre-printing the paper prior to corrugation. The second method comprises laminating pre-printed sheets of paper to the exposed flute. Finally, the third method comprises post-printing directly on to the flat side of an already formed corrugated board. Once formed, it is important not to compress the material since it will lose its essential characteristic of providing a barrier to protect the product. This restricts the means of post-printing processes because some printing processes apply pressure to the finished corrugated material.

Corrugated material may also be used for holding or packing items wherein the corrugated material comprises a single flat sheet and a single corrugated (fluted) sheet. Currently there are only two printing processes available to produce printed single-faced corrugated, pre-printing the paper prior to corrugation or post-printing onto the already formed corrugated sheets. Again, a problem arises in attempting to print on the flat sheet, post corrugation, since it is important to maintain the structure of the corrugated material. This problem is greater with single-faced corrugated material since the structure may not be as strong as the double-faced corrugated material.

It is an aim of the present invention to provide for a third option to produce printed single-faced corrugated overcoming problems associates with the prior art. It is a further aim of the present invention to overcome a problem associated with the prior art whether referred to herein or otherwise.

### SUMMARY OF THE INVENTION

According to a first aspect of the present invention, there is provided a method of producing a laminated single faced flute comprising forming flutes in a first web by embossing the first web in order to produce a fluted web and adhering a printed sheet on to the fluted material.

Preferably, the printed sheet has a high resolution image.

Preferably, the method comprises adhering a plurality of printed sheets on to the fluted material.

According to a second aspect of the present invention, there is provided apparatus for producing a laminated single faced flute comprising embossing means to produce flutes in a first web and adhering means to adhere a printed sheet directly on to the fluted material.

Preferably the printed sheet has a high resolution image thereon.

Preferably, the laminated single faced flute comprises a single fluted layer and a single facing sheet where the single fluted layer comprises an embossed layer and the single facing sheet comprises the printed sheet.

Preferably the printed sheet comprises a lithographic printed sheet.

The fluted material may comprise a fluted web.

The method may comprise cutting the fluted web to produce fluted sheets.

The fluted material may comprise a fluted sheet.

The fluted material may comprise a plurality of fluted sheets.

Preferably, the embossing means comprises a first roller and a second roller. Preferably, the first roller and the second roller have raised profiles defined around the outer periphery thereof. The profile of the second roller may be a mirror image of the profile of the first roller. Preferably the profile of the first and second rollers are provided by teeth. Preferably the teeth of the first roller are arranged, in use, to engage with the teeth of the second roller. Preferably, the first roller and/or the second roller is heated.

The density of the printed sheet may be less than 220 g/m² and preferably is less than 200 g/m² and more preferably is less than 180 g/m².

The density of the printed sheet may be more than 90 g/m² and preferably is more than 100 g/m² and more preferably is more than 110 g/m².

The density of the first web may be less than 150 g/m² and preferably is less than 125 g/m² and more preferably is less than 105 g/m².

The density of the first web may be more than 80 g/m² and preferably is more than 90 g/m².

Preferably, in a region of a support area, the fluted material travels in a first direction. Preferably, the first direction is along the longitudinal extent of the fluted material;

Preferably, in the region of the support area the printed sheet is arranged to move in the first direction.

Preferably, the printed sheets are arranged to be fed singularly on to the fluted material whilst both the printed sheets and the fluted material are travelling in the first direction.

The fluted material having a printed sheet adhered thereto may be cut to produce a sheet of a single faced fluted laminate having a high resolution image displayed thereon.

Preferably, the method is a continuous method or in-line method such that the fluted material is initially formed and the printed sheet is then adhered to the fluted material. The continuous in-line method may include cutting to form sheets of a single faced fluted laminate in a single continuous process or method. Preferably the method is conducted by a single machine and more preferably by a single in-line machine.

Preferably the flutes are non-linear. Preferably the flutes are wavy or have a sawtooth appearance.

The flute may be linear.

Apparatus for producing a laminated single faced flute

According to a third aspect of the present invention, there is provided a holder for holding products, the holder comprising a laminated single faced flute including an embossed flute adhered to a sheet.

Preferably the sheet comprises a printed sheet.

Preferably the sheet has a high resolution image displayed thereon.

According to a fourth aspect of the present invention there is provided an assembly comprising a holder in accordance with the third aspect of the present invention having a product retained therein.

Preferably the holder is made in accordance with the first aspect of the present invention.

The holder may be made by apparatus in accordance with the second aspect of the present invention.

The holder may be arranged, in use, to retain a hot product therein. The holder may be arranged, in use, to retain a liquid container therein. The liquid container may comprise a cup.

Preferably, the holder is dual-ovenable.

Preferably the holder is microwavable.

Preferably the holder comprises a heat resilient material.

### BRIER DESCRIPTION OF THE DRAWINGS

The present invention will now be described, by way of example only, with reference to the drawings that follow, in which:

FIG. 1 is a cross-section of a laminated single faced flute.

FIG. 2 is a plan view of part of a laminated single faced flute.

FIG. 3 is a holder comprising a laminated single faced flute.

FIG. 4 is a side view of a preferred embodiment of apparatus for producing a laminated single faced flute.

FIG. 5 is a side view of another embodiment of apparatus for producing a laminated single faced flute.

### DESCRIPTION OF THE PREFERRED EMBODIMENT

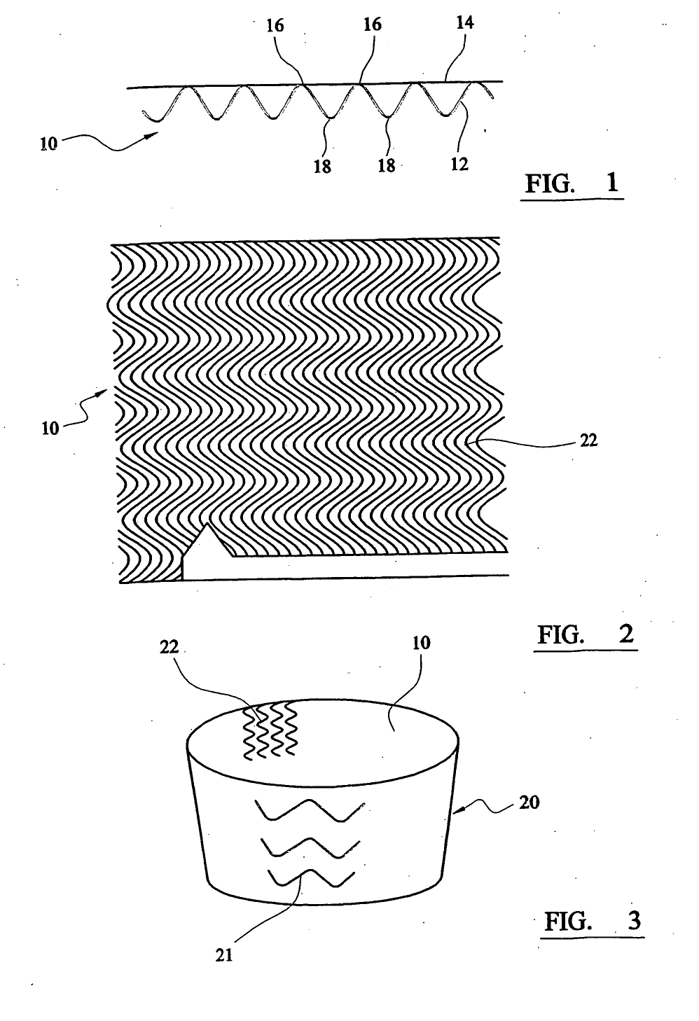

As shown in FIG. 1, a laminated single faced flute comprises a fluted layer 12 and a facing sheet 14. The fluted layer 12 comprises an embossed layer. The laminated single faced flute only comprises a single embossed layer and a single facing sheet. Accordingly, a high resolution print is not simply provided as a separate layer and adhered to the facing sheet which thereby results in three layers. The embossed layer 12 produces an oscillating appearance having peaks 16 and troughs 18. The peaks 16 are secured to the facing sheet 14 by adhering means, for example an adhesive, in order to adhere the facing sheet 14 to the embossed layer 12. The adhesive may be PVA or other suitable adhesive.

The laminated single faced flute 10 may be used in packaging to prevent damage to products contained therein. The embossed layer 12 is able to compress and thereby absorb forces from impacts to prevent damage to a product contained therein. In addition, the laminated single faced flute 10 may be used as a holder 20 (as shown in FIG. 3) to hold and retain warm or hot products therein, for example cups of hot drinks or soup or warm foodstuffs or hot sandwich wraps. The troughs 18 of the embossed layer 12 abut the product and, therefore, the facing sheet 14 is not in direct contact with the product. Accordingly, the transfer of heat is inhibited enabling a user to hold hot products directly in their hand.

The laminated single faced flute 10 comprises a facing sheet 14 or printed sheet having a high resolution image and, in particular, a lithographic image 21 displayed thereon. Other suitable (high resolution or low resolution) printing methods may be used, for example flexographic printing methods. The high resolution print may be produced by a four colour printing process. Lithographic printing methods produce high quality images and are, therefore, highly desirable. However, lithographic printing methods require pressure in order to establish the image. Therefore, if a lithographic printing method was used to print an image on to a facing sheet of a laminated single faced flute, the flute would be compressed and thereby diminishes the desirable characteristic of the flute. Accordingly, the image is printed on to the facing sheet 14 prior to adhering the facing sheet 14 to an embossed web 12. This thereby retains the characteristic of the flutes.

The printed image 21 may contain cooking instructions for the product contained in the holder 20. Preferably, the holder 20 comprises a dual-ovenable material such that the holder 20 and the product could be placed in a microwave or a conventional oven to heat the product within it's container but the holder 20 would act to insulate the container, thereby, enable the user to directly hold the product from the microwave or oven.

The use of high-resolution detail of the printed holder enables the products to be directly used in a retail outlet without the use of further packaging having relevant information provided thereon. Such a further sleeve would increase the cost and use more material.

As shown in FIG. 2, the flutes 22 on the face of the embossed sheet are not linear across the sheet as with conventional flutes. However, in an alternative embodiment of the present invention the flutes may be linear or straight. The flutes 22 are non-linear and are approximately zig-zag in shape and extend across the embossed layer 12 albeit in a generally linear direction. The flutes 22 may also be described as s-shaped or wavy or as having a sawtooth appearance. An advantage of shaped flutes 22 is that if the embossed sheet is linearly folded, the fold will not be urged to coincide with a trough as occurs with conventional linear flutes. Accordingly, if accurate folding of the embossed layer 12 is required then problems may occur with linear flutes since resistive forces encourage the fold to coincide with a trough 18 where the least resistance to folding is located.

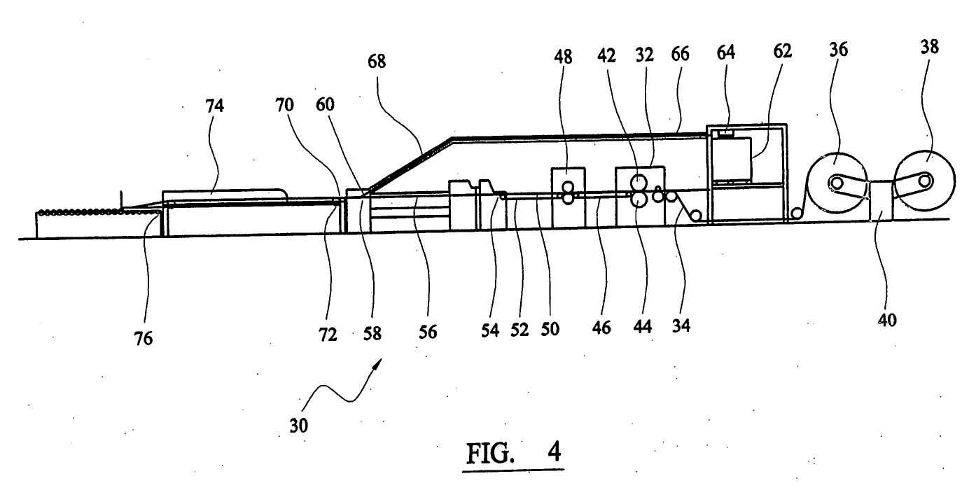

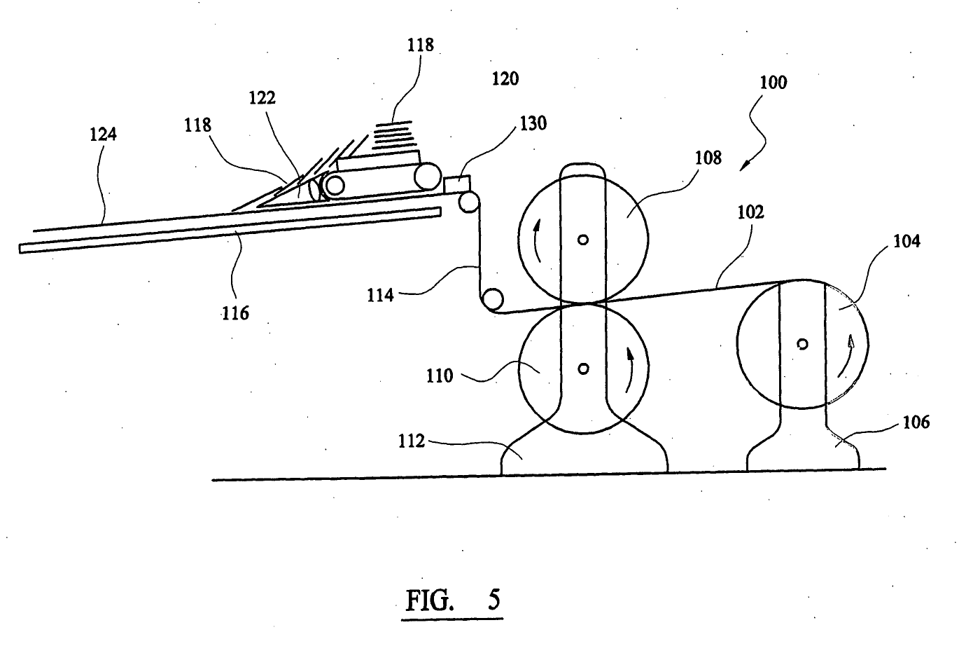

As shown in FIG. 4, apparatus 30 for producing a laminated single faced flute comprises embossing means 32 for embossing a web 34. The apparatus comprises in-line apparatus such that the laminated single faced flute is produced continuously by a single machine performing a continuous process. The web 34 is provided on a roll 36 and is supported by a roll stand 40. The roll stand 40 is adapted to support two rolls 36, 38 such that when the first roll 36 has been used the second roll 38 can be quickly adapted for use.

The embossing means 32 comprises a first roller 42 and a second roller 44. Each roller 42, 44 has a raised profile extending longitudinally along each roller 42, 44, one of which is the opposite of the other in a male and female type configuration in that the raised profile of the first roller 42 engage with recesses of the second roller 44, for example, the teeth of the first roller 42 engage with the teeth of the second roller 44 such that the peaks of the teeth of the first roller locate within the troughs of the second roller and vice versa. The male and female profiles extend longitudinally across the roller in a zig-zag manner in order to create the shaped flutes as previously described. Accordingly, the profile of the first roller 42 is the mirror image of the profile of the second roller 44.

The first roller 42 and the second roller 44 are preferably heated. Accordingly, as the web 34 passes between the male and female profiles (or teeth) of the two rollers, the web 34 is heated. The web 34 is nipped between the profiles of the first and second rollers 42,44. This changes the structure of the web 34 as the web 34 is being shaped between the rollers 42, 44. This results in the web retaining the shape-defined between the roller once the web emerges therefrom. The heated rollers improve the characteristic of the web to retain the shape formed between the rollers. In conventional corrugating the structure of the web is not changed as it simply passes through a set of rollers with raised parallel teeth, like the teeth within a set of gears, about which the paper is fan-folded. In such methods, a second web would need to be adhered to the web immediately in order for the web to retain the shape. In the preferred embodiments the embossed web can be transferred from the embossing means unsupported and over substantial distances, for example in the region of 10 metres.

One or both of the rollers, 42,44 may be driven such that the rotation of the rollers draw the web off the reel and between the rollers. The reel comprises a braking system or tension system such that the momentum of the reel does not cause excess web to be pulled therefrom and also maintains a tension in the web.

The embossed web 46 then travels to cutting means 48 in order to cut the embossed web 46 into embossed sheets 50. The cutting means 48 comprises a cut-off knife.

The embossed sheets 50 then travel on a conveyor 52 and into adhesive applying means 54. The adhesive applying means is arranged to apply an adhesive on to the upper surface of each embossed sheet 50, for example by a surface of an adhesive coated roller contacting the upper surface of the embossed sheets and the surface of the roller also being in contact with an adhesive reservoir in order to replenish the adhesive on the roller. Alternatively, the adhesive applying means may be arranged to apply an adhesive to the printed sheets rather than the embossed web.

The embossed sheets 56 having an upper adhesive surface are then transferred to laminating means 58 in order for the printed layer or printed sheets 60 to be adhered thereto.

The printed sheets 60 and stored in storage means 62 and through a sheet feeder 64 are transferred on to conveying means 66. The conveying means 66 extends horizontally above the embossing means 32, cutting means 48 and adhesive applying means 54 in order for the apparatus 30 to be relatively compact.

The printed sheets 60 are then transferred onto a conveying ramp 68 where the printed sheets 60 are partially overlapped such that the lower end of a higher sheet locates on top of the upper end of an adjacent lower sheet.

The printed sheets 60 are then transferred or shingled down to the laminating means 58 where a lithographic printed sheet 60 is adhered on to the upper surface of an embossed sheet 56 to create a sheet of laminated single faced flute 70. The sheets of laminated single faced flute 70 are then compressed by compression means 72 in order to aid the adhesion between the lithographic printed sheets and the embossed sheets.

The sheets of laminated single faced flute then pass through drying means 74 or heating in order for the adhesive to dry.

Finally, the sheets of laminated single faced flute are conveyed to stacking means 76 where the sheets are stacked conveniently for distribution.

The apparatus may comprise a festoon area if the embossing rollers need to run at a different rate compared to the adhesive section. The festoon area provides a temporary storage area for the embossed web.

As shown in FIG. 5, another embodiment of apparatus 100 for producing a laminated single faced flute comprises a support means comprising a stand for supporting a reel 104 of a web 102. The reel 104 is rotatably supported on the stand 106 such that the web 102 can be continuously pulled off the reel 104. Again, the reel 104 comprises a tension system.

The web 102 passes from the reel 104 to the embossing means. The embossing means comprises a first roller 108 and a second roller 110. The first and second rollers 108, 110 are supported on support means comprising a stand 112. The first and second rollers 108, 110 are rotatably supported on the stand 112. The first and second rollers 108, 110 have male and female raised profiles in order to continuously emboss the web. The first and second rollers 108, 110 are heated in order for the fluted shape of the web to be retained as previously explained. Accordingly, the embossed web 114 can then be moved out of the embossing means without having to immediately adhere a strengthening sheet thereto.

The embossed web 114 is transferred to a support area including a planar support. The distance between the embossing means and the support area may be relatively large, for example greater than 1 m and also possibly greater than 5 m.

The support area includes support means 120 for supporting printed sheets 118 thereon. The support area further comprises movement means for moving the printed sheets 118 from a storage position into contact with the embossed web.

The embossed web 114 moves relative to the support 116 in a first direction. The first direction is along the longitudinal length of the embossed web. The printed sheets 118 are moved from the storage position and into contact with the embossed sheet in the first direction. The printed sheets shingle down the ramp portion 122 and will overlap as they shingle down. Accordingly, the lead edge of the printed sheet initially contacts a face of the embossed web and both then travel in the same direction whilst the remainder of the face of the printed sheet is located over the embossed web.

The printed sheet is adhered to the embossed web by adhesive means. The adhesive means comprises an adhesive, for example P.V.A. The printed sheet makes contact with the peaks of the embossed web in order to adhere thereto. The adhesive is located on to the embossed web by adhesive supply means 130.

The single faced fluted laminate is produced as a web. 124 in a continuous method or process by a single piece of apparatus or by a single machine.

Initially, a web is embossed to produce an embossed web, an adhesive is then supplied to the embossed web, printed sheets are then adhered to the embossed web to produce a single faced fluted laminate web displaying printed images, and the web is then cut to produce single faced fluted laminate sheets having printed images displayed thereon. Alternatively, the embossed web may be cut prior to adhering the printed sheets thereto. Finally, drying means is provided in order to dry the adhesive.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

1. A method of producing a laminated single faced flute comprising forming flutes in a first web by embossing the first web in order to produce a fluted web and adhering a printed sheet on to the fluted material.

2. A method of producing a laminated single faced flute according to claim 1 in which the printed sheet has a high resolution image.

3. A method of producing a laminated single faced flute according to claim 1 in which the method comprises adhering a plurality of printed sheets on to the fluted material.

4. Apparatus for producing a laminated single faced flute comprising embossing means to produce flutes in a first web and adhering means to adhere a printed sheet directly on to the fluted material.

5. Apparatus for producing a laminated single faced flute according to claim 4 in which the printed sheet has a high resolution image thereon.

6. Apparatus for producing a laminated single faced flute according to claim 4 in which the laminated single faced flute comprises a single fluted layer and a single facing sheet where the single fluted layer comprises an embossed layer and the single facing sheet comprises the printed sheet.

7. Apparatus for producing a laminated single faced flute according to claim 4 in which the printed sheet comprises a lithographic printed sheet.

8. Apparatus for producing a laminated single faced flute according to claim 4 in which the fluted material comprises a fluted web.

9. Apparatus for producing a laminated single faced flute according to claim 4 in which the fluted material comprises a plurality of fluted sheets.

10. Apparatus for producing a laminated single faced flute according to claim 4 in which the embossing means comprises a first roller and a second roller.

11. Apparatus for producing a laminated single faced flute according to claim 10 in which the first roller and the second roller have raised profiles defined around the outer periphery thereof.

12. Apparatus for producing a laminated single faced flute according to claim 11 in which the profile of the second roller is a mirror image of the profile of the first roller.

13. Apparatus for producing a laminated single faced flute according to claim 11 in which the profiles of the first and second rollers are provided by teeth.

14. Apparatus for producing a laminated single faced flute according to claim 13 in which the teeth of the first roller are arranged, in use, to engage with the teeth of the second roller.

15. Apparatus for producing a laminated single faced flute according to claim 10 in which the first roller and/or the second roller is heated.

16. Apparatus for producing a laminated single faced flute according to claim 4 in which the density of the printed sheet is less than 180 g/m².

17. Apparatus for producing a laminated single faced flute according to claim 4 in which the density of the printed sheet is more than 110 g/m².

18. Apparatus for producing a laminated single faced flute according to claim 4 in which the density of the first web is less than 105 g/m².

19. Apparatus for producing a laminated single faced flute according to claim 4 in which the density of the first web is more than 90 g/m².

20. Apparatus for producing a laminated single faced flute according to claim 4 in which, in a region of a support area, the fluted material travels in a first direction.

21. Apparatus for producing a laminated single faced flute according to claim 20 in which the first direction is along the longitudinal extent of the fluted material.

22. Apparatus for producing a laminated single faced flute according to claim 4 in which the printed sheets are arranged to be fed singularly on to the fluted material whilst both the printed sheets and the fluted material are traveling in a first direction.

23. Apparatus for producing a laminated single faced flute according to claim 4 in which the fluted material having a printed sheet adhered thereto is cut to produce a sheet of a single faced flute laminate having a high resolution image displayed thereon.

24. A method according to claim 1 in which the method is a continuous method or in-line method such that the fluted material is initially formed and the printed sheet is then adhered to the fluted material.

25. A method according to claim 24 in which the continuous in-line method includes cutting to form sheets of a single faced fluted laminate in a single continuous process or method.

26. A method according to claim 1 in which the method is conducted by a single in-line machine.

27. Apparatus for producing a laminated single faced flute according to claim 4 in which the flutes are non-linear.

28. A holder for holding products, the holder comprising a laminated single faced flute including an embossed flute adhered to a printed sheet.

29. A holder for holding products according to claim 28 in which the sheet has a high resolution image displayed thereon.

30. An assembly comprising a holder according to claim 28 wherein the holder has a product retained therein.

31. An assembly according to claim 30 in which the holder is arranged, in use, to retain a hot product therein.

32. An assembly according to claim 30 in which the holder is arranged, in use, to retain a liquid container therein.

33. An assembly according to claim 32 in which the liquid container comprises a cup.

34. An assembly according to claim 30 in which the holder is dual-ovenable.

35. An assembly according to claim 30 in which the holder is microwavable.

36. An assembly according to claim 30 in which the holder comprises a heat resilient material.

37-40. (canceled)

41. A method according to claim 24 in which the method is conducted by a single in-line machine.
